(19) United States
(12) Patent Application Publication
(10) Pub. No.: US 2015/0315036 A1
(43) Pub. Date: Nov. 5, 2015

(54) Water Evaporator Enhancer

(71) Applicant: Benjamin Clegg, Hyde Park, UT (US)

(72) Inventor: Benjamin Clegg, Hyde Park, UT (US)

(21) Appl. No.: 14/267,567

(22) Filed: May 1, 2014

(51) Int. Cl. C02F 1/04; E21B 41/00; C02F 1/08

(52) U.S. Cl. CPC C02F 1/048; C02F 1/043; C02F 1/08; E21B 41/005; C02F 2103/10

(57) ABSTRACT

A solar assisted water evaporator that includes a hollow elongate member and drive mechanism for enhancing water evaporation from a waste water source optimized to maintain a quantity of waste water about an exterior of the hollow elongate member to minimize scaling during the evaporative process.

### PRIORITY CLAIM

This application claims priority to U.S. Provisional Application 61/812,308 filed on May 5, 2013 entitled “A WATER EVAPORATOR ENHANCER” which is incorporated herein in its entirety by reference.

### FIELD OF THE TECHNOLOGY

The present technology relates to a water evaporation device and, more particularly, to a water evaporation device for use in a waste water evaporation system.

### BACKGROUND

In industry, different water emitting sources produce large volumes of water that have concentrations of dissolved elements that make them hazardous for normal discharge in the environment. These hazardous water sources are expensive to transport, store and dispose of in every industry. For example, the oil and gas produced water needs to be collected from wells, moved to a disposal well facility or evaporation pond for disposal. The disposal of hazardous waters include direct injection, environmentally acceptable direct-use of untreated water, or treatment to a standard defined by the U.S. Environmental Protection Agency (EPA) before disposal or supply to users.

Management of produced water can be problematic. For example, disposal through direct injection may not be feasible. Typically, large-scale on-site storage and/or disposal require significant investment costs towards large and expensive infrastructure. Trucking water off-site for disposal involves high transport costs. Therefore, cost efficient, on-site solutions to produced water disposal and management are sought.

Evaporation technologies are known in the art, but current designs have significant drawbacks. For example, produced water can be evaporated at small on-site evaporation ponds. While relatively low-cost, these ponds still create relatively large surface area disturbance and they may also be attractive and/or harmful to wildlife. Also, water may be sprayed into the atmosphere through portable misting towers. But, misting can lead to salt damage to soil and vegetation. Evaporation may be achieved by introducing thermal elements into smaller volumes of water to speed evaporation. But, the resulting precipitates tend to create scaling, which adheres to heating elements over time, reduces efficiency, and creates maintenance issues. Therefore, efficient and environmentally safe solutions for the evaporative disposal of produced water are elusive. In light of the above problems and needs, a new and innovative evaporator enhancer is needed.

### BRIEF DESCRIPTION OF THE FIGURES

To further clarify the above and other aspects of the present technology, a more particular description of the technology will be rendered by reference to specific aspects thereof which are illustrated in the appended drawings. It is appreciated that these drawings depict only typical aspects of the technology and are therefore not to be considered limiting of its scope. The drawings are not drawn to scale. The technology will be described and explained with additional specificity and detail through the use of the accompanying drawings in which:

FIG. 1 discloses a water evaporation device for use in evaporating water from a waste water source in accordance with one aspect of the technology;

FIG. 2 discloses a water evaporation device for use in evaporating water from a waste water source in accordance with one aspect of the technology; and

FIG. 3 discloses a close up view of a portion of the device shown in FIG. 1.

### DETAILED DESCRIPTION

The following detailed description of exemplary aspects of the technology makes reference to the accompanying drawings, which form a part hereof and in which are shown, by way of illustration, exemplary aspects in which the technology may be practiced. While these exemplary aspects are described in sufficient detail to enable those skilled in the art to practice the technology, it should be understood that other aspects may be realized and that various changes to the technology may be made without departing from the spirit and scope of the present technology. Thus, the following more detailed description of the aspects of the present technology is not intended to limit the scope of the technology, as claimed, but is presented for purposes of illustration only and not limitation to describe the features and characteristics of the present technology, to set forth the best mode of operation of the technology, and to sufficiently enable one skilled in the art to practice the technology. Accordingly, the scope of the present technology is to be defined solely by the appended claims.

The following detailed description and exemplary aspects of the technology will be best understood by reference to the accompanying drawings, wherein the elements and features of the technology are designated by numerals throughout.

Generally speaking, the technology includes a hollow elongate member 50 partially submerged in a body of waste water. The hollow elongate member 50 is rotated at a predetermined rate of rotation in an effort to maintain a film of waste water about the unsubmerged portions of the hollow member 50. The rate of rotation is a function of several factors including, but not limited to, the size of the elongate member, the percentage of the member that is submerged, the ambient temperature, humidity, and wind speed. In this manner, scale is minimized about the elongate members and evaporation is enhanced while minimizing other negatives associated with other forms of waste water evaporation.

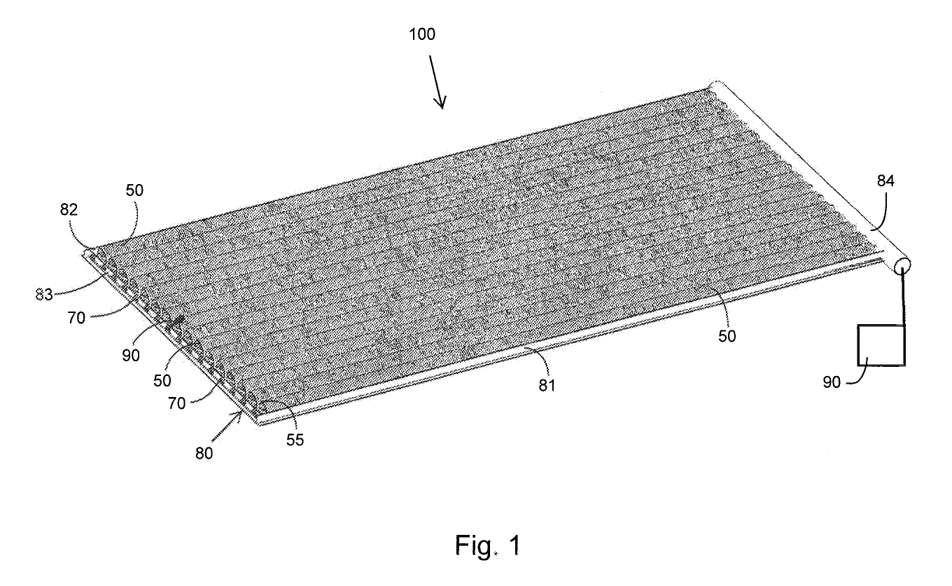

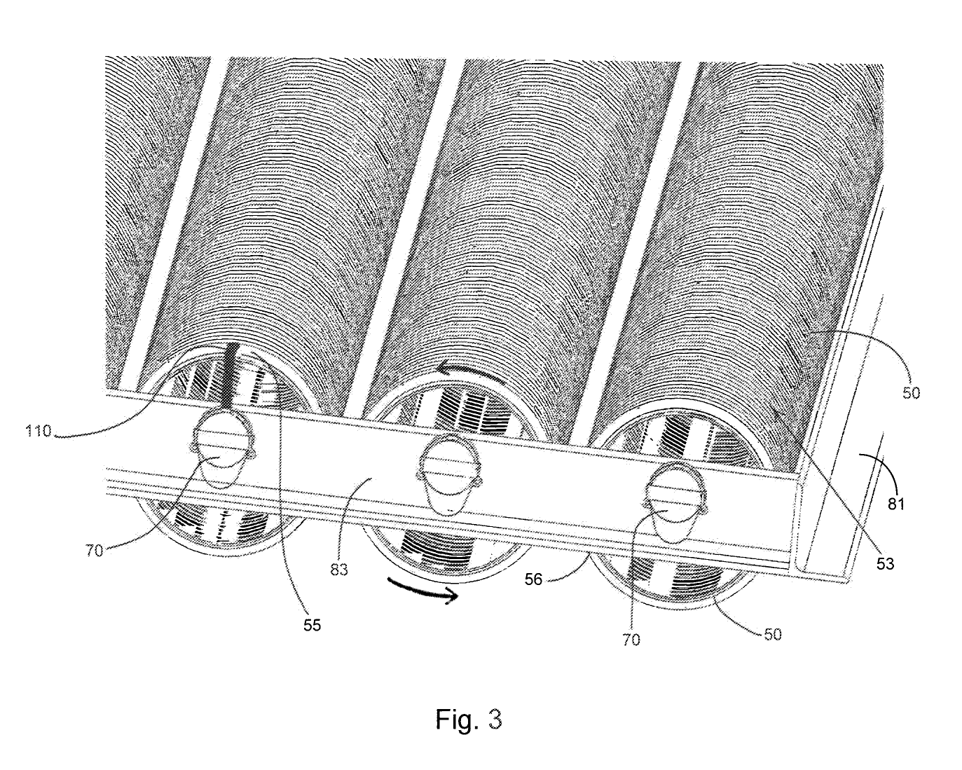

Referring now to FIGS. 1 and 3, a perspective view of one aspect of an evaporator 100 is shown. In accordance with one aspect of the technology, a hollow elongate member 50 partially is submerged within a body of waste water, the hollow elongate member 50 having a first end 51 and a second end 52, wherein the first end 51 of the hollow elongate member 50 is disposed about the first end of the body of waste water and the second end 52 of the hollow elongate member 50 is disposed about the second end of the body of waste water. An exterior of the hollow elongate member 50 comprises a plurality of alternating concentric ridges 53. In one aspect of the technology, the ridges 53 are concentric with a central longitudinal axis of the hollow elongate member 50. The ridges 53 increase the total surface area about the exterior of the elongate members 50 thereby increasing the evaporative surface. In one aspect of the technology, the elongate members 50 are each coupled to a variable speed motor 70 disposed about one end of the hollow elongate member 50. The motor 70 is operatively coupled to the hollow elongate member 50 by way of a rigid or flexible shaft member 71. The motor 70 is configured to rotate the hollow elongate member 50 about its central longitudinal axis.

In one aspect of the technology, a plurality of elongate members 50 are aligned parallel to one another within a frame 80. The frame 80 comprises substantially flat light-weight plastic side members 81, 82 disposed about opposite sides of the plurality of elongate members 50 and substantially parallel to the elongate members 50. The side members 81, 82 are operatively coupled to a front member 83. The front member 83 is coupled to the motor 70 which operates to rotate the elongate members 50. The frame 80 also comprises a rear member 84 that is substantially perpendicular to the elongate members 50. In one aspect of the technology, the rear member 84 is hollow and is operatively coupled to each of the plurality of elongate hollow members 50 by a plurality of hollow tubes. The hollow tubes permit fluid communication between the rear member 84 and the elongate hollow members 50. In accordance with one aspect of the technology, a thermal blower 90 is operatively coupled to the rear member 84.

In accordance with one aspect of the technology, the motor 70 is configured to rotate the elongate hollow members 50 at a minimum rate required to maintain a film of waste water about the unsubmerged portion of the elongate member 50. In one aspect of the technology, a minimum film thickness of 1 millimeter is desired, though other thicknesses are contemplated herein depending on a particular application. In this manner, scale accumulation about the elongate members 50 is minimized while evaporation is maximized. The rotational speed is a function of a variety of factors including the amount of the elongate hollow member submerged, the size of the elongate hollow member, the ambient temperature, wind speed, humidity, temperature of the water, and temperature of the elongate hollow member; all factors that affect evaporative rates. For example, it is believed that a hollow elongate member that is 18 inches in diameter with a maximum surface area of twenty-five percent submerged in a body of water will optimally be rotated at approximately 1 rotation per minute where the ambient temperature is approximately 75 degrees Fahrenheit, relatively low wind speed and an average humidity ranging between twenty and forty percent. However, if humidity were held constant and ambient temperature is increased substantially, the rate of evaporation would increase requiring an increase in the rate of rotation.

In one aspect of the technology, the elongate members comprise hollow cylindrical members ranging from between 6 and 48 inches in diameter. While the cylindrical members can be made of numerous types of materials, in one aspect, they comprise black acrylonitrile butadiene styrene, black polyethylene, black unplasticized polyvinyl chloride, black polyvinyl chloride, black post chlorinated polyvinyl chloride, black polypropylene, or black polyvinylidene fluoride. This material absorbs heat energy from the sun and in turn promotes the evaporative process. Other thermally absorptive materials are contemplated for use herein. Moreover, in one aspect of the technology, the elongate member is a double walled plastic pipe with air pockets incorporated into its structure to provide flotation.

In one aspect of the technology, a maximum of 25 percent of the surface area of the elongate hollow member is submerged in the waste water. The amount of submerged elongate member, however, will vary depending on the size of the member. For example, a smaller diameter elongate member will have smaller total surface area and will be submerged less than a larger diameter elongate member in an effort to maximize the surface area exposed to evaporation. The energy required to rotate a smaller elongate member may also be less than that required to rotate a larger elongate member, depending on the amount of the elongate member that is submerged in the waste water. In one aspect of the technology, the rate of rotation varies from approximately 0.5 to 2.5 rotations per minute though this rate may also vary as suits a particular purpose.

The rotational speed of the motors may be manually adjusted in accordance with desired operation parameters. In accordance with one aspect of the technology, a moisture sensor 110 is operatively coupled to the motor 70 and on a top 55 of the unsubmerged portion of the elongate member 50. The moisture sensor 110 is configured to detect the amount of moisture present on the top 55 of each of the elongate members 50 and further configured to communicate with the motors 70 to increase the rate of rotation when a threshold amount of moisture is not detected. For example, if the moisture sensor 110 fails to detect that a layer of at least 1 millimeter of water is not present on an unsubmerged portion of the elongate member 50, a signal is transmitted to the motor 70 to increase the rate of rotation until the minimum amount of moisture is detected. While reference is made to placement of the sensor 110 about the top 55 of the elongate member 50, it is understood that the moisture sensor 110 may be placed at different locations on the unsubmerged elongate member 50 as suits a particular purpose. For example, in one aspect of the technology, the sensor 110 is placed near a side surface 56 of the unsubmerged elongate member 50 near the point where the exposed rotating portion of the elongate member 50 re-enters the waste water referred to herein as the “falling” side. Moreover, while reference is made to a required quantity of 1 millimeter of water, it is understood that the sensor 110 may be modified to communicate with the motor 70 to increase the speed of rotation at any different quantity of water as suits a particular purpose. In addition, the sensor 110 may be configured to reduce the rate of rotation when an upper level of moisture accumulation on the elongate members 50 is reached. In this manner, only the minimum amount of energy is expended to maintain the minimum desired amount of waste water on the exterior of the elongate member 50.

In another aspect of the technology, a flow meter is operatively coupled to an unsubmerged surface of the elongate hollow member. Specifically, a wiper is deployed near the “falling” side surface of the elongate hollow member, or the side that is nearest the waste water as the unsubmerged portion rotates into the waste water. The wiper diverts water remains on the “falling” side of the elongate hollow member into a flow meter. The flow meter is operatively coupled to the motor and, similar to the moisture sensor referenced above, communicates with the motor to increase the rate of rotation until a minimum predetermined flow threshold is achieved.

In another aspect of the technology, a thermal blower 90 is operatively coupled to the rear member 84 of the frame 80. The thermal blower 90 is equipped with a thermostat and configured to transmit a volume of heated air to the rear member 84 and throughout the hollow elongate members when the ambient temperature drops to below a threshold value. For example, it is believed that when the ambient temperature drops below 40 degrees Fahrenheit, the energy required to operate the blower is justified by the relative increase in evaporation rates when temperatures drop below 30 degrees Fahrenheit, the volume is increased.

With reference generally to FIGS. 1 and 3, in one aspect of the technology, the evaporative system covers an open-water impoundment. By covering the impoundment, water fowl and other wildlife are not attracted to the impoundment which may contain materials that are hazardous to the wildlife. In one aspect, the system is implemented as a flotation system which covers substantially all of the open-water impoundment or, alternatively, is implemented as a modular system that only covers a small portion of the impoundment. The modular system is deployed atop the impoundment and is moved, manually, by wind or otherwise, about the top of the impoundment.

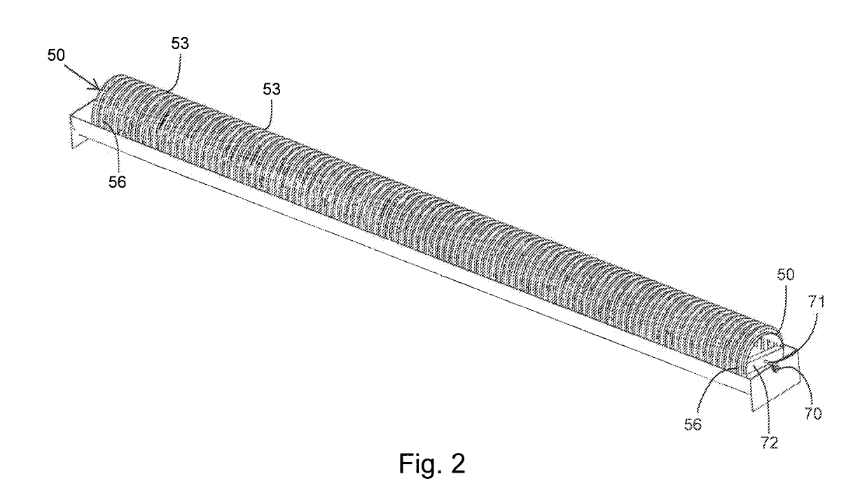

With specific reference to FIG. 2, in one aspect of the technology, an open-top container 120 is disclosed. The open-top container 120, or trough, contains a volume of waste water. An elongate hollow member 50 is disposed within the trough 120 and is operatively coupled to a motor 70 which is configured to rotate the elongate member 50 about a longitudinal central axis. The motor 70 is coupled to the hollow elongate member 50 by way of a shaft 71 that mates with a cross-bar 72 mounted within an opening in one end of the elongate hollow member 50.

In one aspect of the invention, the hollow elongate member is coated with a hydrophilic composition. In this manner, the waste water has a greater proclivity to “adhere” to the hollow elongate member thereby being exposed to evaporative forces. For example, in one aspect of the technology, the hydrophilic coating comprises a polyelectrolyte and non-ionic hydrophilic polymer. Said hydrophilic coating is formed by curing a hydrophilic coating formulation comprising the polyelectrolyte and the non-ionic hydrophilic polymer. Preferably the polyelectrolyte and the non-ionic hydrophilic polymer are covalently and/or physically bound to each other and/or entrapped to form a polymer network after curing. In another aspect of the technology, the hydrophilic coating comprises the polyelectrolyte, the non-ionic hydrophilic polymer and a supporting network, which may be a hydrophilic supporting network, and which is formed from a supporting monomer or polymer. Herein the supporting monomer or polymer, apart from comprising a plurality of reactive moieties capable of undergoing cross-linking reactions and may also contain hydrophilic functional groups. Said hydrophilic coating is formed by curing a hydrophilic coating formulation comprising the polyelectrolyte, the non-ionic hydrophilic polymer and the supporting monomer or polymer. Preferably the polyelectrolyte and/or the non-ionic hydrophilic polymer and/or the hydrophilic supporting network are covalently linked and/or physically bound to each other and/or entrapped to form a polymer network after curing.

In the hydrophilic coating formulation which is used to produce said hydrophilic coating, the weight ratio of non-ionic hydrophilic polymer to supporting monomer or polymer may for example vary between 10:90 and 90:10, such as between 25:75 and 75:25 or such as between 60:40 and 40:60. A supporting network can he formed upon curing a supporting monomer or polymer or any combination of supporting monomers and polymers comprising a plurality of reactive moieties capable of undergoing cross-linking reactions, which may be present in the hydrophilic coating formulation. The reactive moiety of the supporting monomer or polymer may be selected from the group consisting of radically reactive groups, such as alkenes, amino, amido, sulfhydryl (SH), unsaturated esters, ethers and amides, and alkyd/dry resins. The supporting monomer or polymer may have a backbone and at least one of the above-mentioned reactive moieties. The backbone of the supporting polymer may be selected from the group consisting of polyethers, polyurethanes, polyethylenes, polypropylenes, polyvinyl chlorides, polyepoxides, polyamides, polyacrylamides, poly(meth)acrylics, polyoxazolidones, polyvinyl alcohols, polyethyleneimines, polyesters like polyorthoesters and alkyd copolymers, polypeptides, or polysaccharides such as cellulose and starch or any combination of the above. In particular, a supporting monomer, polymers with unsaturated esters, amides or ethers, thiol or mercaptan groups may suitably be used in the invention.

As used herein, the term supporting monomer refers to molecules with a molecular weight of less than approximately 1000 g/mol, and the term supporting polymer is used for molecules with a molecular weight of approximately 1000 g/mol or more. Generally the supporting monomer or polymer has a molecular weight in the range of about 500 to about 100,000 g/mol, and preferably is a polymer with a molecular weight in the range of about 1,000 to about 10,000 g/mol.

The foregoing detailed description describes the technology with reference to specific exemplary aspects. However, it will be appreciated that various modifications and changes can be made without departing from the scope of the present technology as set forth in the appended claims. The detailed description and accompanying drawings are to be regarded as merely illustrative, rather than as restrictive, and all such modifications or changes, if any, are intended to fall within the scope of the present technology as described and set forth herein.

More specifically, while illustrative exemplary aspects of the technology have been described herein, the present technology is not limited to these aspects, but includes any and all aspects having modifications, omissions, combinations (e.g., of aspects across various aspects), adaptations and/or alterations as would be appreciated by those skilled in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus-function are expressly recited in the description herein. Accordingly, the scope of the technology should be determined solely by the appended claims and their legal equivalents, rather than by the descriptions and examples given above.

1. A water evaporation device for use in evaporating water from a waste water source, comprising:
a body of waste water disposed in an open-top container, the container having a first end and a second end;
a hollow elongate member partially submerged within the body of waste water, the hollow elongate member having a first end and a second end, wherein the first end of the hollow elongate member is disposed about the first end of the container and the second end of the hollow elongate member is disposed about the second end of the container;
wherein an exterior of the hollow elongate member comprises a plurality of alternating concentric ridges.

2. The water evaporation device of claim 1, further comprising a variable speed motor disposed about one end of the hollow elongate member operatively coupled to the hollow elongate member and configured to rotate the hollow elongate member about a central longitudinal axis of the hollow elongate member.

3. The water evaporation device of claim 2, wherein the motor rotates the hollow elongate member at a rate of between 0.5 to 2.0 rotations per minute.

4. The water evaporation device of claim 1, wherein a maximum of twenty-five percent of the hollow elongate member is submerged in the body of waste water.

5. The water evaporation device of claim 1, wherein the hollow elongate member comprises black acrylonitrile butadiene styrene, black polyethylene, black unplasticized polyvinyl chloride, black polyvinyl chloride, black post chlorinated polyvinyl chloride, black polypropylene, or black polyvinylidene fluoride.

6. The water evaporation device of claim 1, wherein the hollow elongate member comprises an inner diameter ranging between 6 to 48 inches.

7. The water evaporation device of claim 1, further comprising a thermal blower operatively coupled to the plurality of hollow elongate members.

8. The water evaporation device of claim 7, wherein the thermal blower is configured to transmit a volume of heated air to a hollow portion of the hollow elongate member when an ambient temperature is detected that is below a threshold level.

9. The water evaporation device of claim 2, further comprising a moisture sensor operatively coupled to the motor and further operatively coupled to an exterior portion of the hollow elongate member.

10. The water evaporation device of claim 9, wherein the motor increases the rotation of the hollow elongate members when the moisture sensor detects that a moisture level on the exterior of the hollow elongate member has dropped below a predetermined threshold.

11. A system for enhancing evaporation of waste water, comprising:
a hollow elongate member partially submerged within a body of waste water, wherein the hollow elongate member is disposed about a central longitudinal axis of the hollow elongate member;
a motor disposed about one end of the hollow elongate member operatively coupled to the hollow elongate member and configured to rotate the hollow elongate member about the central longitudinal axis of the hollow elongate member at a predetermined rotational speed; and
a moisture sensor operatively coupled to the motor and further operatively coupled to an exterior portion of the hollow elongate member, wherein the motor increases the rotation of the hollow elongate member when the moisture sensor detects that a moisture level on the exterior of the hollow elongate member has dropped below a predetermined threshold.

12. The system of claim 11, further comprising a thermal blower operatively coupled to the hollow elongate member.

13. The system of claim 12, wherein the thermal blower is configured to transmit a volume of heated air to a hollow portion of the hollow elongate member when an ambient temperature is detected that is below a threshold level.

14. The system of claim 11, wherein an outer portion of the hollow elongate member comprises a hydrophilic composition.

15. A method of enhancing evaporation, comprising:
rotating a hollow elongate member with a variable speed motor within a body of waste water, wherein an exterior of the hollow elongate member comprises a plurality of alternating concentric ridges and wherein a maximum of twenty-five percent of the hollow elongate member is submerged within the body of waste water;
determining a moisture level on an un-submerged portion of the hollow elongate member;
increasing the rotational speed of the hollow elongate member within the body of waste water when the moisture level drops below a predetermined threshold.

16. The method of claim 15, wherein the hollow elongate member comprises an inner diameter ranging between 12 to 24 inches.

17. The method of claim 15, wherein an outer portion of the hollow elongate member has been treated with a hydrophilic composition.

18. The method of claim 15, wherein the hollow elongate member is rotated at the minimum rotational speed required to maintain a minimum film of waste water about the exterior of the hollow elongate member of 1 millimeter.

19. The method of claim 18, further comprising transmitting a volume of heated air to a hollow portion of the hollow elongate member when an ambient temperature is detected below a threshold level.

20. The method of claim 19, further comprising increasing the volume of the heated air when an ambient temperature is detected below a second threshold level.
